(19) United States
(12) Patent Application Publication
(10) Pub. No.: US 2025/0280791 A1
(43) Pub. Date: Sep. 11, 2025

(54) BODY-WORN PET CONE GARMENT DEVICE

(71) Applicant: Victorine Ngangu, Los Angeles, CA (US)

(72) Inventor: Victorine Ngangu, Los Angeles, CA (US)

(21) Appl. No.: 19/049,516

(22) Filed: Feb. 10, 2025

Related U.S. Application Data
(60) Provisional application No. 63/562,724, filed on Mar. 8, 2024.

(51) Int. Cl. A01K 13/00; A01K 27/00

(52) U.S. Cl. CPC A01K 13/006; A01K 27/002; A01K 27/006; A01K 27/008

(57) ABSTRACT

A body-worn pet cone garment device is provided and is designed to enhance stability, security, and comfort for animals recovering from injuries or surgical procedures. The device comprises a vest with an attached protective cone, ensuring a secure fit and preventing displacement during pet movement. The vest incorporates leg openings for easy wearability and may be made of stretchable, waterproof, and anti-bacterial materials to enhance durability, hygiene, and odor control. The vest may be comprised of adjustable fasteners for a customizable fit and multi-point leash attachment options ensure optimal control and pressure distribution. Additional features such as pockets, reflective elements for nighttime visibility, and a customizable identification tag further improve functionality. The protective cone is securely attached to the vest and may be made of flexible or rigid materials, depending on recovery needs. Anti-slip reinforcement, cushioning layers, and ventilation openings enhance comfort by preventing irritation and overheating.

### CROSS-REFERENCE TO RELATED APPLICATION

The present application claims priority to, and the benefit of, U.S. Provisional Application No. 63/562,724, which was filed on Mar. 8, 2024, and is incorporated herein by reference in its entirety.

### FIELD OF THE INVENTION

The present invention relates generally to the field of pet cones. More specifically, the present invention relates to a vest with an attached protective cone to ensure a secure fit and prevent displacement. The vest features adjustable fasteners, multi-point leash attachments, and additional elements such as waterproof and anti-bacterial materials, pockets, reflective components, and ventilation openings for improved durability, hygiene, and pet comfort. Accordingly, the present disclosure makes specific reference thereto. Nonetheless, it is to be appreciated that aspects of the present invention are also equally applicable to other like applications, devices, and methods of manufacture.

### BACKGROUND

When a pet undergoes surgery or sustains an injury, it is often necessary to use a protective cone to prevent them from licking or scratching the affected area. However, traditional protective cones can be unstable, leading to issues with movement, comfort, and security. When a dog wears a standard cone, attaching a leash securely can be challenging. The cone may shift, causing discomfort or even allowing the dog to slip out of both the cone and the leash, creating a safety hazard, especially outdoors. Additionally, improperly secured cones can fail to protect the wound site effectively, leading to potential infections and complications. Pet owners often struggle with readjusting or securing the cone while maintaining control of their pets, particularly during walks. Existing solutions, such as separate harnesses or adjustable cones, do not always provide a stable, secure, and comfortable fit. Furthermore, some materials used in traditional cones may cause irritation or discomfort over extended periods, reducing the pet's willingness to wear them. As a result, there is a need for an improved solution that enhances security, stability, and comfort while ensuring that the cone remains in place during all activities.

Therefore, there exists a long-felt need in the art for a body-worn pet cone garment device that securely integrates a protective cone with a vest to prevent shifting and displacement. There also exists a long-felt need in the art for a body-worn pet cone garment device that provides a stable and reliable leash attachment mechanism to prevent pets from escaping while wearing the cone. Moreover, there exists a long-felt need in the art for a body-worn pet cone garment device that enhances pet comfort and usability through adjustable fasteners, cushioning elements, and breathable materials.

The subject matter disclosed and claimed herein, in one embodiment thereof, comprises a body-worn pet cone garment device. The device is comprised of a body-worn pet cone garment device designed to enhance stability, security, and comfort for animals recovering from injuries or surgical procedures. The device comprises a vest with an attached protective cone, ensuring a secure fit and preventing displacement during pet movement. The vest incorporates leg openings for easy wearability and may be made of stretchable, waterproof, and anti-bacterial materials to enhance durability, hygiene, and odor control. The vest may be comprised of adjustable fasteners for a customizable fit and multi-point leash attachment options ensure optimal control and pressure distribution. Additional features such as pockets, reflective elements for nighttime visibility, and a customizable identification tag further improve functionality. The protective cone is securely attached to the vest and may be made of flexible or rigid materials, depending on recovery needs. Anti-slip reinforcement, cushioning layers, and ventilation openings enhance comfort by preventing irritation and overheating.

In this manner, the body-worn pet cone garment device of the present invention accomplishes all the forgoing objectives and provides a pet cone with a securely fitted vest to maintain stability and security. The inclusion of adjustable fasteners allows pet owners to achieve a customized fit, ensuring that the cone remains in the proper position to prevent licking or scratching. The device also incorporates a multi-point leash attachment system, allowing for safe and controlled outdoor movement without the risk of escape. Additionally, the vest is designed with comfort-enhancing features such as soft cushioning, breathable materials, and an anti-slip reinforcement to prevent irritation and discomfort. The integration of antimicrobial linings and waterproof coatings further improves hygiene and durability. By combining stability, security, and comfort, the device offers a superior alternative to traditional protective cones, ensuring both effective wound protection and improved pet safety.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a body-worn pet cone garment device designed to enhance stability, security, and comfort for pets recovering from injuries or surgical procedures. The device is comprised of a vest that serves as the primary stabilization mechanism for a protective cone.

The vest includes at least one leg opening for easy slip-in wearability and may be made from stretchable materials such as elastic fabric, neoprene, or spandex-blended textiles. In some embodiments, the vest material features a waterproof coating to prevent moisture absorption, enhancing durability and hygiene. The vest may also include at least one fastener allowing for an adjustable fit. Additionally, at least one leash-attachment fastener may be positioned at various points on the vest to provide secure leash attachment and optimal pressure distribution.

At least one pocket may be included for carrying small essentials, secured by a closure mechanism. Some embodiments of the vest may incorporate a reflective element to enhance visibility in low-light conditions. The vest may further feature an anti-bacterial lining made of silver-ion-treated fabric, copper-infused textiles, or antimicrobial polymer coatings to minimize odor buildup and prevent infections.

A protective cone is fixedly attached to the vest to prevent displacement during pet movement. The cone may be made of flexible or rigid materials, accommodating various recovery needs. An anti-slip reinforcement along the inner rim, using rubberized coatings, silicone grips, or additional fastening mechanisms, ensures stability. A cushioning layer made of memory foam, gel padding, or soft fabric lining may be integrated to reduce neck discomfort. Additionally, ventilation openings in the form of perforations, mesh panels, or vents may be included to improve airflow and prevent overheating.

A customizable identification tag may be positioned on the vest and/or cone, made of materials such as an engraved metal plate or embroidered patch, to store owner contact details or medical information.

Accordingly, the body-worn pet cone garment device of the present invention is particularly advantageous as it provides a pet cone with a securely fitted vest to maintain stability and security. The inclusion of adjustable fasteners allows pet owners to achieve a customized fit, ensuring that the cone remains in the proper position to prevent licking or scratching. The device also incorporates a multi-point leash attachment system, allowing for safe and controlled outdoor movement without the risk of escape. Additionally, the vest is designed with comfort-enhancing features such as soft cushioning, breathable materials, and an anti-slip reinforcement to prevent irritation and discomfort. The integration of antimicrobial linings and waterproof coatings further improves hygiene and durability. By combining stability, security, and comfort, the device offers a superior alternative to traditional protective cones, ensuring both effective wound protection and improved pet safety. In this manner, the body-worn pet cone garment device overcomes the limitations of existing pet cones known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a body-worn pet cone garment device of the present invention in accordance with the disclosed architecture; and

FIG. 2 illustrates a flowchart of a method of using one potential embodiment of a body-worn pet cone garment device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a body-worn pet cone garment device that securely integrates a protective cone with a vest to prevent shifting and displacement. There also exists a long-felt need in the art for a body-worn pet cone garment device that provides a stable and reliable leash attachment mechanism to prevent pets from escaping while wearing the cone. Moreover, there exists a long-felt need in the art for a body-worn pet cone garment device that enhances pet comfort and usability through adjustable fasteners, cushioning elements, and breathable materials.

The present invention, in one exemplary embodiment, is comprised of a body-worn pet cone garment device. A body-worn pet cone garment device is designed to improve stability, security, and comfort for pets recovering from injuries or surgical procedures. The device is comprised of a vest that functions as the primary stabilization mechanism for a protective cone.

The vest includes at least one leg opening for easy slip-in wearability and may be constructed from stretchable materials such as elastic fabric, neoprene, or spandex-blended textiles. In some embodiments, the vest material features a waterproof coating to prevent moisture absorption, enhancing durability and hygiene. The vest may also include at least one fastener for an adjustable fit. Additionally, at least one leash-attachment fastener may be positioned at different locations on the vest to ensure secure leash attachment and optimal pressure distribution.

At least one pocket may be included for carrying small essentials, secured with a closure mechanism. Some embodiments incorporate a reflective element to enhance visibility in low-light conditions. The vest may also feature an anti-bacterial lining made of silver-ion-treated fabric, copper-infused textiles, or antimicrobial polymer coatings to reduce odor buildup and prevent infections.

A protective cone is fixedly attached to the vest to prevent displacement during pet movement. The cone may be made from flexible or rigid materials to accommodate different recovery needs. An anti-slip reinforcement along the inner rim, using rubberized coatings, silicone grips, or additional fastening mechanisms, ensures stability. A cushioning layer, made from memory foam, gel padding, or soft fabric lining, may be integrated to reduce neck discomfort. Additionally, ventilation openings in the form of perforations, mesh panels, or vents may be included to enhance airflow and prevent overheating.

A customizable identification tag may be placed on the vest and/or cone, made from materials such as an engraved metal plate or embroidered patch, to store owner contact details or medical information.

The body-worn pet cone garment device offers a significant advantage by integrating a securely fitted vest with a protective cone, ensuring stability and security. The inclusion of adjustable fasteners allows for a customized fit, keeping the cone properly positioned to prevent licking or scratching. A multi-point leash attachment system enhances safe and controlled outdoor movement, reducing the risk of escape. Comfort-enhancing features including soft cushioning, breathable materials, and an anti-slip reinforcement prevent irritation and discomfort. The integration of antimicrobial linings and waterproof coatings further improves hygiene and durability. By combining stability, security, and comfort, the device provides a superior alternative to traditional protective cones, effectively protecting wounds while enhancing pet safety.

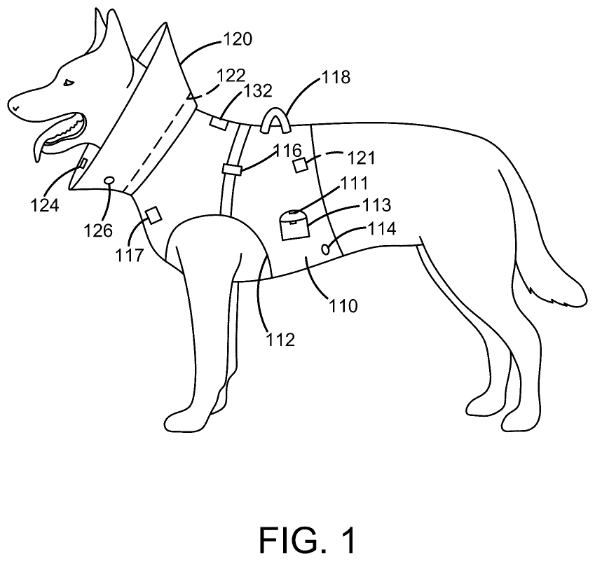

Referring initially to the drawings, FIG. 1 illustrates a perspective view of one potential embodiment of a body-worn pet cone garment device 100 of the present invention in accordance with the disclosed architecture. The body-worn pet cone garment device 100 is designed to improve stability, security, and comfort for animals recovering from injuries or surgical procedures. The body-worn pet cone garment device 100 is comprised of a vest 110 that serves as the primary stabilization mechanism for a protective cone 120.

The vest 110 is comprised of at least one leg opening 112 that allows easy slip-in wearability. The vest 110 may be comprised of a stretchable material such as, but not limited to, elastic fabric, neoprene, spandex-blended textiles, or other flexible and form-fitting materials. In one embodiment, the material of the vest 110 is comprised of a waterproof coating 114 to prevent moisture absorption, enhancing durability and maintaining hygiene.

In another embodiment, the vest 110 may be comprised of at least one fastener 116 that allows the vest 110 to be tightened and/or loosened around the body of a pet, as seen in FIG. 1. The fastener 116 includes, but is not limited to, a hook and loop fastener, a magnetic fastener, a buckle fastener, a strap fastener, or a snap fastener. The vest 110 may also be comprised of at least one leash-attachment fastener 118, such as, but not limited to, a ring, a clip, a loop, or a reinforced fabric attachment. The leash-attachment fastener 118 may be positioned at the chest, back, and sides of the vest 110 to offer various leash attachment options, ensuring optimal control and reducing pressure on any single area of the pet's body.

The vest 110 may also be comprised of at least one pocket 113 that allows owners to carry small essentials such as waste bags, treats, or medication. The pocket 113 may be comprised of a secured closure mechanism 111, including, but not limited to, a zipper, a hook and loop fastener, or an elastic opening, preventing accidental loss of stored items.

In one embodiment, the material of the vest 110 is reflective and/or is comprised of a reflective element 117 (as seen in FIG. 1) to enhance visibility during low-light conditions, ensuring safety during nighttime walks. The reflective element 117 may be in the form of reflective strips, patches, or integrated reflective fibers woven into the fabric.

The vest 110 may further be comprised of an anti-bacterial lining 121 to reduce odor buildup and prevent infections in areas where the vest 110 contacts the pet's skin. The anti-bacterial lining 121 may be comprised of silver-ion-treated fabric, copper-infused textiles, or antimicrobial polymer coatings.

At least one cone 120 is fixedly attached to the vest 110, as seen in FIG. 1. The cone 120 is configured to remain securely in place, preventing displacement or loosening during pet movement. In various embodiments, the cone 120 may be made of flexible or rigid material such as, but not limited to, plastic, reinforced fabric, thermoplastic polyurethane (TPU), silicone, or laminated composites, accommodating different recovery needs based on injury severity and pet behavior.

The cone 120 may be comprised of an anti-slip reinforcement 122 along its inner rim to prevent shifting or rotation during movement. The anti-slip reinforcement 122 may be achieved through rubberized coatings, silicone grips, or additional fastening mechanisms integrated into the connection between the cone 120 and the vest 110.

In another embodiment, the cone 120 may be comprised of a cushioning layer 124 along its inner surface to prevent discomfort and irritation around the pet's neck. The cushioning layer 124 may be comprised of memory foam, gel padding, or soft fabric lining.

In one embodiment, the cone 120 may be comprised of at least one ventilation opening 126 to improve airflow and prevent overheating. The ventilation opening 126 may be in the form of perforations, mesh panels, or strategically placed vents to promote breathability.

The body-worn pet cone garment device 100 may further be comprised of a customizable identification tag 132 positioned on the vest 110 and/or cone 120. The identification tag 132 may be comprised of an engraved metal plate, an embroidered patch, etc. that can store owner contact details, medical information, or other relevant data.

The body-worn pet cone garment device 100 provides an enhanced solution for pets recovering from injuries or surgical procedures. By integrating a securely fitted vest 110 with a fixed protective cone 120, the device 100 prevents cone displacement, ensures reliable leash attachment, and maximizes pet comfort. The combination of adjustable fasteners 116, multi-point leash attachments 118, anti-slip reinforcement 122, and additional comfort-enhancing features such as the cushioning layer 124 and ventilation opening 126 offers superior security and ease of use compared to traditional protective cones.

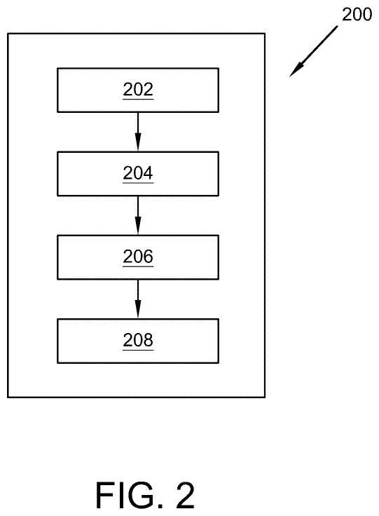

The present invention is also comprised of a method of using 200 the body-worn pet cone garment device 100, as seen in FIG. 2. First, a body-worn pet cone garment device 100 is provided, comprised of a vest 110 and a cone 120 fixedly attached to the vest 110 [Step 202]. Then, the vest 110 is placed onto a pet by inserting the pet's legs through at least one leg opening 112 and securing the vest 110 around the pet's body using at least one fastener 116 [Step 204]. Next, the cone 120 is adjusted around the pet to ensure the device 100 remains securely in place, preventing displacement during pet movement [Step 206]. Finally, a leash-attachment fastener 118 may be used to attach a leash to the vest 110 for controlled movement of the pet, and any pocket 113 may be used to store small essentials as needed [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “body-worn pet cone garment device” and “device” are interchangeable and refer to the body-worn pet cone garment device 100 of the present invention.

Notwithstanding the forgoing, the body-worn pet cone garment device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the body-worn pet cone garment device 100 as shown in the FIGS. are for illustrative purposes only, and that many other sizes and shapes of the body-worn pet cone garment device 100 are well within the scope of the present disclosure. Although the dimensions of the body-worn pet cone garment device 100 are important design parameters for user convenience, the body-worn pet cone garment device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A body-worn pet cone garment device comprising:
a vest comprising:
a leg opening configured to allow slip-in wearability;
a stretchable material configured to conform to a pet's body;
a fastener configured to adjust the fit of the vest around the pet's body; and
a cone fixedly attached to the vest, the cone being configured to remain securely in place during pet movement to prevent displacement or loosening.

2. The body-worn pet cone garment device of claim 1, wherein the fastener is comprised of a hook and loop fastener.

3. The body-worn pet cone garment device of claim 1, wherein the fastener is comprised of a magnetic fastener.

4. The body-worn pet cone garment device of claim 1, wherein the fastener is comprised of a buckle fastener.

5. The body-worn pet cone garment device of claim 1, wherein the fastener is comprised of a strap fastener.

6. The body-worn pet cone garment device of claim 1, wherein the fastener is comprised of a snap fastener.

7. A body-worn pet cone garment device comprising:
a vest comprising:
a leg opening configured to allow slip-in wearability;
a stretchable material configured to conform to a pet's body;
a leash-attachment fastener;
a fastener configured to adjust the fit of the vest around the pet's body;
a cone fixedly attached to the vest, the cone being configured to remain securely in place during pet movement to prevent displacement or loosening; and
wherein the cone is comprised of an anti-slip reinforcement.

8. The body-worn pet cone garment device of claim 7, wherein the vest is comprised of a waterproofing coating.

9. The body-worn pet cone garment device of claim 7, wherein the vest is comprised of a reflective element.

10. The body-worn pet cone garment device of claim 7, wherein the cone is rigid.

11. The body-worn pet cone garment device of claim 7, wherein the cone is comprised of a cushioning layer.

12. The body-worn pet cone garment device of claim 7, wherein the leash-attachment fastener is comprised of a ring, a clip, or a loop.

13. The body-worn pet cone garment device of claim 7, wherein the vest is comprised of an identification tag.

14. A body-worn pet cone garment device comprising:
a vest comprising:
a leg opening configured to allow slip-in wearability;
a stretchable material configured to conform to a pet's body;
a leash-attachment fastener;
a pocket;
a fastener configured to adjust the fit of the vest around the pet's body;
a cone fixedly attached to the vest, the cone being configured to remain securely in place during pet movement to prevent displacement or loosening; and
wherein the cone is comprised of an anti-slip reinforcement and a ventilation opening.

15. The body-worn pet cone garment device of claim 14, wherein the cone is flexible.

16. The body-worn pet cone garment device of claim 14, wherein the anti-slip reinforcement is comprised of a rubberized coating.

17. The body-worn pet cone garment device of claim 14, wherein the pocket is comprised of a closure mechanism.

18. The body-worn pet cone garment device of claim 14, wherein the vest is comprised of an anti-bacterial lining.

19. The body-worn pet cone garment device of claim 14, wherein the ventilation opening is comprised of a mesh panel.

20. The body-worn pet cone garment device of claim 14, wherein the ventilation opening is comprised of a perforation.
